(19) United States
(12) Patent Application Publication
(10) Pub. No.: US 2007/0191980 A1
(43) Pub. Date: Aug. 16, 2007

(54) Method for managing tools using statistical process control

(75) Inventors: Yu-Wen Ho, Hsinchu City (TW); Tung-Pin Hsu, Hsinchu City (TW); Chien-Chung Chen, Hsinchu City (TW)

Correspondence Address: BIRCH STEWART KOLASCH & BIRCH, PO BOX 747, FALLS CHURCH, VA, 22040-0747, US

(73) Assignee: Powerchip Semiconductor Corp.

(21) Appl. No.: 11/637,105

(22) Filed: Dec. 12, 2006

(30) Foreign Application Priority Data
Feb. 16, 2006 (TW) 95105196

(51) Int. Cl. G06F 19/00

(52) U.S. Cl. 700/110; 700/121

(57) ABSTRACT

A method for managing tools using statistical process control. Process progression for a wafer in a chamber of a process tool is recorded. When a wafer process is complete and the wafer leaves the chamber, the wafer is transferred to a measurement tool. A wafer ID of the wafer is obtained using the measurement tool. A chamber ID is obtained according to the wafer ID and a chart point corresponding to the wafer ID and the chamber ID is generated according to measurement results. A plurality of generated chart points are grouped according to a plurality of obtained wafer IDs and a plurality of chamber IDs corresponding to the wafer IDs to split a control chart corresponding to the process tool into a plurality of separate control charts. Statistical process control analysis is implemented according to the generated control charts and alarms are issued according to the analysis results to adjust an abnormal chamber.

### BACKGROUND OF THE INVENTION

1. Field of the Invention

The invention relates to statistical process control (SPC) in semiconductor manufacturing, and in, particular to a method for managing tools using statistical process control.

2. Description of the Related Art

Current commercially available manufacturing execution system (MES) packages are used throughout the semiconductor manufacturing sector. These systems track each wafer and determine where it has been and where the wafer needs to go. The model, however, is limited by incorrect statistical process control (SPC) employed by most commercially available packages is a naive model with assumptions built into the system that are incorrect, i.e., one parameter is measured, at one place, using only one type of product, only once. For example, most SPC systems are entity and lot-based, but in practice the factory is chamber and wafer-based. From an automation user's point of view, these SPC systems are difficult for programmers to maintain and enhance. Also, at least in part because of the describe assumptions, these SPC systems require many statistical process control charts (over 14,000 for a typical Fab operation) for effective process monitoring. Maintaining so many charts is costly, hinders change, and can obscure important statistics. In addition, due to the monolithic nature of charting systems used with current semiconductor SPC systems, producing a statistical process control chart for viewing is typically a labor-intensive process.

In a semiconductor facility company, tools can manufacture wafers, monitor manufacturing operations, transfer wafers, and the like. During operation of a tool, multiple parameters are repeatedly monitored. Wafers, for example, can be processed in a chamber of a tool and the tool controls parameters, such as pressure, temperature, and manufacturing period duration. During the manufacture, a large amount of process data is generated and repeated monitoring of the parameters and detecting defects in the process data is time-consuming.

In conventional manufacturing systems, a manufacturing execution (MES) receives and analyzes process parameters and data to control tools using SPC. Currently, each wafer lot is measured using a measurement tool and a measurement parameter serves as a chart point in a control chart. Additionally, a previous process tool acts as a monitored object. The level of variation in the monitored object is estimated using weight efficiency indexes based on control charts generated by multiple chart points. The described SPC method executes lot-based and tool-based analyses for further analysis of wafer level and chamber level analyses, suffers from the following drawbacks. If control chart variation can not be immediately obtained when each wafer is processed to implement corresponding process operations but all wafers for each wafer lot are completely processed for further adjustment, a large amount of wafer damage may occur. Additionally, in a process tool, different chambers may result in different process conditions, such that there may be discrepancies in wafers generated from different chambers. If each chart point is controlled by lot-level SPC, discrepancies for each wafer are displayed in an SPC chart point of a control chart, such that wafer damage resulting from changes in a chamber are not immediately reflected.

Thus, an improved method for managing tools using statistical process control is desirable.

### BRIEF SUMMARY OF THE INVENTION

A method for managing tools using statistical process control is provided. Process progression for a wafer in a chamber of a process tool is recorded. When a wafer process is complete and the wafer leaves the chamber, the wafer is transferred to, a measurement tool. A wafer ID of the wafer is obtained using the measurement tool. A chamber ID is obtained according to the wafer ID and a chart point corresponding to the wafer ID and the chamber ID is generated according to measurement results. A plurality of generated chart points are grouped according to a plurality of obtained wafer IDs and a plurality of chamber IDs corresponding to the wafer IDs to split a control chart corresponding to the process tool into a plurality of separate control charts. Statistical process control analysis is implemented according to the generated control charts and alarms are issued according to the analysis results to adjust an abnormal chamber.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of an embodiment of a method for managing tools using statistical process control.

### DETAILED DESCRIPTION OF THE INVENTION

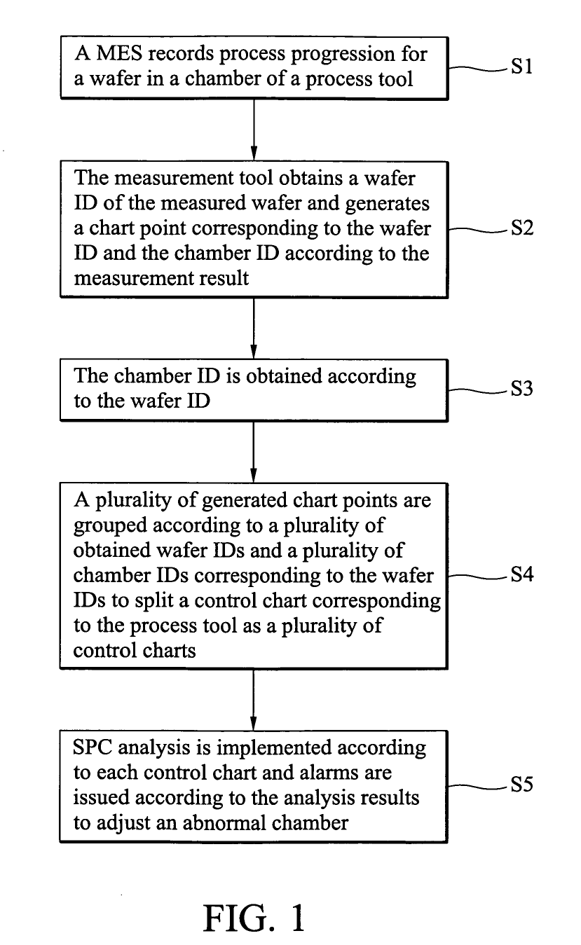

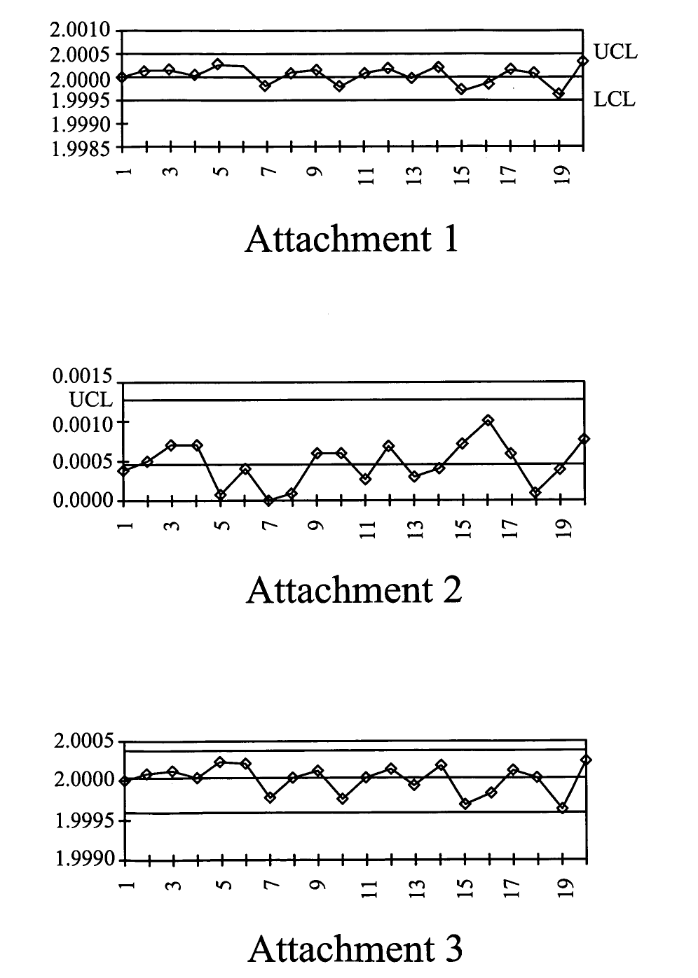

Several exemplary embodiments of the invention are described with reference to FIG. 1, which generally relate to managing tools using statistical process control. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention discloses a method for managing tools using statistical process control (SPC).

FIG. 1 is a flowchart of an embodiment of a method for managing tools using statistical process control.

A manufacturing execution system (MES) records process progression for a wafer in a chamber of a process tool (step S1). Each process tool comprises multiple chambers. Traditionally, when each wafer enters a chamber to complete a process, quality of each wafer may be vary due to various conditions in the chambers. Thus, in this embodiment, when a wafer enters a chamber of the process tool, a chamber ID of the chamber and the process progression for the wafer entering and leaving the chamber is recorded.

Next, when a wafer process is complete and the wafer leaves the chamber, the wafer is transferred to a measurement tool. The measurement tool obtains a wafer ID of the measured wafer and generates a chart point corresponding to the wafer ID and the chamber ID according to the measurement results (step S2). Next, the chamber ID is obtained according to the wafer ID (step S3).

A plurality of generated chart points, corresponding to the same chamber ID, in lot-level or wafer-level SPC control charts are grouped according to a plurality of obtained wafer IDs and a plurality of chamber IDs corresponding to the wafer IDs to split a control chart corresponding to the process tool into a plurality of separate control charts (step S4). Each split control chart can reflect and express effect changes of different chambers, and SPC analysis is implemented according to each control chart and alarms are issued according to the analysis results to adjust an abnormal chamber (step S5).

Examples of managing tools using the SPC of the invention are described in the following.

Referring to Attachment 1, each control chart provides a criterion, an upper control limit (UCL), and a lower control limit (LCL). Conventional SPC analyzes all processed wafers from a process tool using a measurement tool and generates a control chart according to the analysis results, comprising wafer data from different chambers. An abnormal condition of a chamber may be regarded as a normal condition by the MES since another abnormal condition for another chamber is also detected, such that an alarm for the process tool is not issued, thereby resulting in quality discrepancy. The SPC method of the invention generates corresponding control charts according to different chambers, splits the control chart shown in Attachment 1 into separate control charts shown in Attachments 2 and 3. Attachment 2 illustrates a control chart for a chamber (chamber A) of the process tool while Attachment 3 illustrates a control chart for another chamber (chamber B) of the process tool.

Referring to the control chart shown in Attachment 2, multiple chart points are located under the UCL, indicating abnormal conditions in chamber A corresponding to the control chart exist, such that the chamber A must be adjusted to prevent defective wafers. Referring to the control chart shown in Attachment 3, multiple chart points are located between the UCL and the LCL and closely approach the criterion, indicating that no abnormal conditions in chamber A corresponding to the control chart have been detected, such that the chamber does not require adjustment.

A method for managing tools using the statistical process control of the invention splits SPC control charts based on different chambers of a process tool, enabling immediate detection of effect changes in a chamber via SPC control charts to immediately issue alarms, effectively reducing the risk of wafer damage. Additionally, when a large number of wafer-level and chamber-level process data is processed, process states can be effectively monitored and optimum adjustment to production lines can be implemented as soon as possible to reduce wafer damage.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for managing tools using statistical process control, comprising:
recording process progression for a wafer in a chamber of a process tool;
when a wafer process is complete and the wafer leaves the chamber, transferring the wafer to a measurement tool;
obtaining a wafer ID of the wafer using the measurement tool;
obtaining a chamber ID according to the wafer ID and generating a chart point corresponding to the wafer ID and the chamber ID according to measurement results;
grouping a plurality of generated chart points according to a plurality of obtained wafer IDs and a plurality of chamber IDs corresponding to the wafer IDs to split a control chart corresponding to the process tool into a plurality of separate control charts; and
implementing statistical process control analysis according to the generated control charts and issuing alarms according to the analysis results to adjust an abnormal chamber.

2. The method for managing tools using statistical process control as claimed in claim 1, further comprising recording process progressions for each wafer in a chamber of the process tool.

3. The method for managing tools using statistical process control as claimed in claim 2, further comprising:
recording a chamber ID when a wafer enters one of the chambers of the process tool; and
recording process progression when the wafer enters and leaves the chamber of the process tool.

4. The method for managing tools using statistical process control as claimed in claim 3, further comprising grouping chart points corresponding to identical chamber IDs in a lot level or wafer level SPC control chart to split the SPC control chart into the separate control charts.

5. The method for managing tools using statistical process control as claimed in claim 4, further comprising reflecting performance variations of different chambers of the process tool according to the split control charts.

6. A computer-readable storage medium storing a computer program providing a method for managing tools using statistical process control, comprising using a computer to perform the steps of:
recording process progression for a wafer in a chamber of a process tool;
when a wafer process is complete and the wafer leaves the chamber, transferring the wafer to a measurement tool;
obtaining a wafer ID of the wafer using the measurement tool;
obtaining a chamber ID according to the wafer ID and generating a chart point corresponding to the wafer ID and the chamber ID according to measurement results;
grouping a plurality of generated chart points according to a plurality of obtained wafer IDs and a plurality of chamber IDs corresponding to the wafer IDs to split a control chart corresponding to the process tool into a plurality of separate control charts; and
implementing statistical process control analysis according to the generated control charts and issuing alarms according to the analysis results to adjust an abnormal chamber.

7. The computer-readable storage medium as claimed in claim 6, further comprising recording process progressions for each wafer in a chamber of the process tool.

8. The computer-readable storage medium as claimed in claim 7, further comprising:
recording a chamber ID when a wafer enters one of the chambers of the process tool; and
recording process progression when the wafer enters and leaves the chamber of the process tool.

9. The computer-readable storage medium as claimed in claim 8, further comprising grouping chart points corresponding to identical chamber IDs in a lot level or wafer level SPC control chart to split the SPC control chart into the separate control charts.

10. The computer-readable storage medium as claimed in claim 9, further comprising reflecting performance variations of different chambers of the process tool according to the split control charts.
